(19) United States
(12) Patent Application Publication
(10) Pub. No.: US 2014/0183992 A1
(43) Pub. Date: Jul. 3, 2014

(54) MOTOR AND MANUFACTURING METHOD THEREOF

(71) Applicant: SAMSUNG ELECTRO-MECHANICS CO., LTD, Suwon (KR)

(72) Inventors: Sang Ho SEO, Suwon (KR); Sung Tai Jung, Suwon (KR); Yong Wan Cho, Suwon (KR); Myung Geun OH, Suwon (KR); Hee Soo Yoon, Suwon (KR)

(73) Assignee: SAMSUNG ELECTRO-MECHANICS CO., LTD, Suwon (KR)

(21) Appl. No.: 13/775,799

(22) Filed: Feb. 25, 2013

(30) Foreign Application Priority Data
Dec. 27, 2012 (KR) 10-2012-0155288

(51) Int. Cl. H02K 3/32; H02K 15/00

(52) U.S. Cl. CPC H02K 3/32; H02K 15/0068
USPC 310/71; 29/596

(57) ABSTRACT

There are provided a switched reluctance motor which can be easily manufactured and available for automation, and a manufacturing method thereof. The motor includes: a stator with a coil wound therearound; and a control board coupled to one side of the stator, the coil being electrically connected to the control board, wherein the control board includes a coupling recess in which the coil is fixedly bonded and a guide recess allowing the coil to be moved into the coupling recess from the outside of the control board.

### CROSS-REFERENCE TO RELATED APPLICATIONS

This application claims the priority of Korean Patent Application No. 10-2012-0155288 filed on Dec. 27, 2012, in the Korean Intellectual Property Office, the disclosure of which is incorporated herein by reference.

### BACKGROUND OF THE INVENTION

1. Field of the Invention

The present invention relates to a motor and a manufacturing method thereof, and more particularly, to a switched reluctance motor which can be easily manufactured and that is available for automation, and a manufacturing method thereof.

2. Description of the Related Art

In a general switched reluctance motor (SRM), torque is generated by controlling power supplied to a coil wound around a multi-phase stator.

Here, forward torque may be generated by magnetic pull by sequentially varying an excitation state between a rotor and a stator, and when a particular excitation state is not varied, the rotor may be stopped at a predetermined position. Also, various types of driving that may generate reverse torque by controlling a phase of an input pulse signal applied to a switching element based on a maximum inductance configuration as a starting point have been extensively applied to electronic products requiring directional control.

Conventionally, a configuration of a motor in which a control board is installed on a stator is largely used. Also, related art motors are manufactured by winding a coil around a stator, installing a control board on one side of the stator, and bonding the coil wound around the stator to a coil connection terminal of the control board for a connection.

In particular in the related art, a through hole is formed in a control board, the coil wound around the stator is led out through the through hole of the control board and bonded to an outer surface of the control board to manufacture a motor.

Thus, in order to manufacture a related art motor, the process of winding a coil around a stator, the process of disposing a control board on one side of the stator, the process of leading out a lead-out wire of the coil through the through hole formed in the control board, and the process of bonding the lead-out wire of the coil to the control board should be sequentially performed.

Thus, in the related art motor, since the coil is inserted into the through hole of the control board one turn by one turn, a manufacturing time is considerably lengthened.

Also, since the process of inserting a coil into the control board is manually performed, manufacturing costs are increased.

### RELATED ART DOCUMENT

(Patent document 1) Korean Patent Laid Open Publication No. 1999-0041082

### SUMMARY OF THE INVENTION

An aspect of the present invention provides a motor which is easily manufactured and available for automation, and a manufacturing method thereof.

According to an aspect of the present invention, there is provided a motor, including: a stator with a coil wound therearound; and a control board coupled to one side of the stator, the coil being electrically connected to the control board, wherein the control board includes a coupling recess in which the coil is fixedly bonded and a guide recess allowing the coil to be moved into the coupling recess from the outside of the control board.

The guide recess may be configured as a path connecting an outer side of the control board and the coupling recess.

The coupling recess may extend from the guide recess.

The guide recess may have a width reduced in a direction toward the coupling recess.

The guide recess may have a width corresponding to a diameter of the coil in a direction toward the coupling recess.

The control board may have a bonding pad bonded to the coil in the vicinity of the coupling recess.

According to another aspect of the present invention, there is provided a method for manufacturing a motor, including: preparing a stator with a coil wound therearound; disposing a lead-out wire of the coil such that it is bent in an outer diameter direction from the stator; coupling the control board to one side of the stator; and inserting the lead-out wire into a coupling recess of the control board.

In the inserting of the lead-out wire, the lead-out wire may be moved through a guide recess formed near the coupling recess from an outer side of the control board.

In the disposing of the lead-out wire of the coil by bending, the lead-out wire may be disposed in a position corresponding to the guide recess of the control board.

The method may further include: bonding the lead-out wire to the bonding pad formed in the vicinity of the coupling recess.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically illustrating a motor according to an embodiment of the present invention;

FIG. 2 is an exploded perspective view schematically illustrating the motor of FIG. 1;

FIG. 3 is a plan view schematically illustrating a control board of FIG. 1;

FIG. 4 is an enlarged view of portion ‘A’ in FIG. 3; and

FIGS. 5 through 8 are views illustrating a method for manufacturing a motor according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

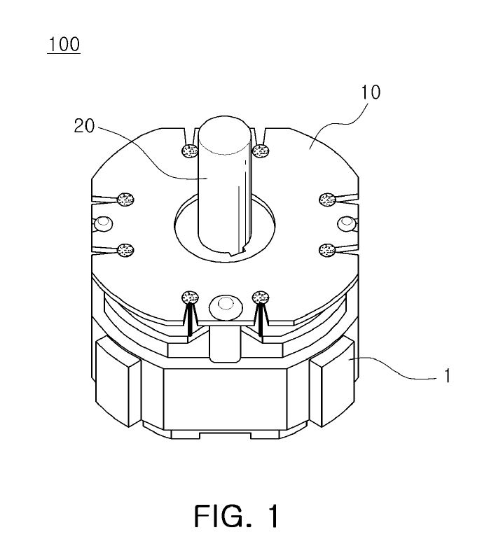

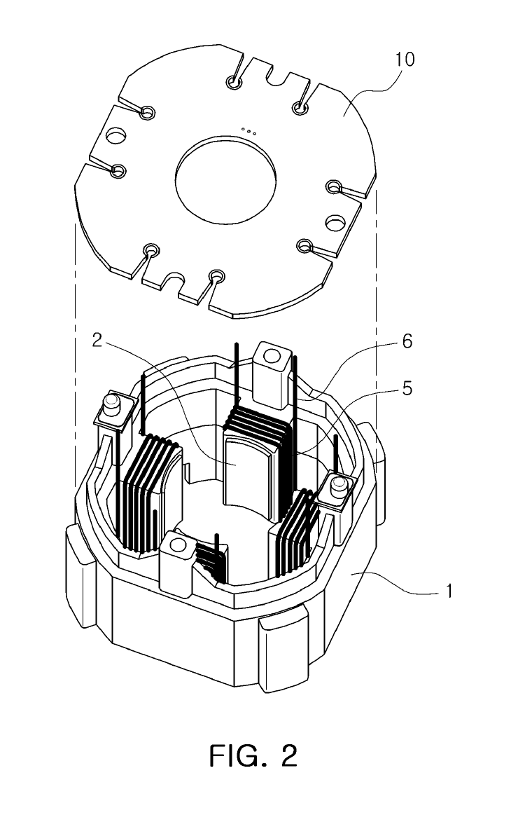

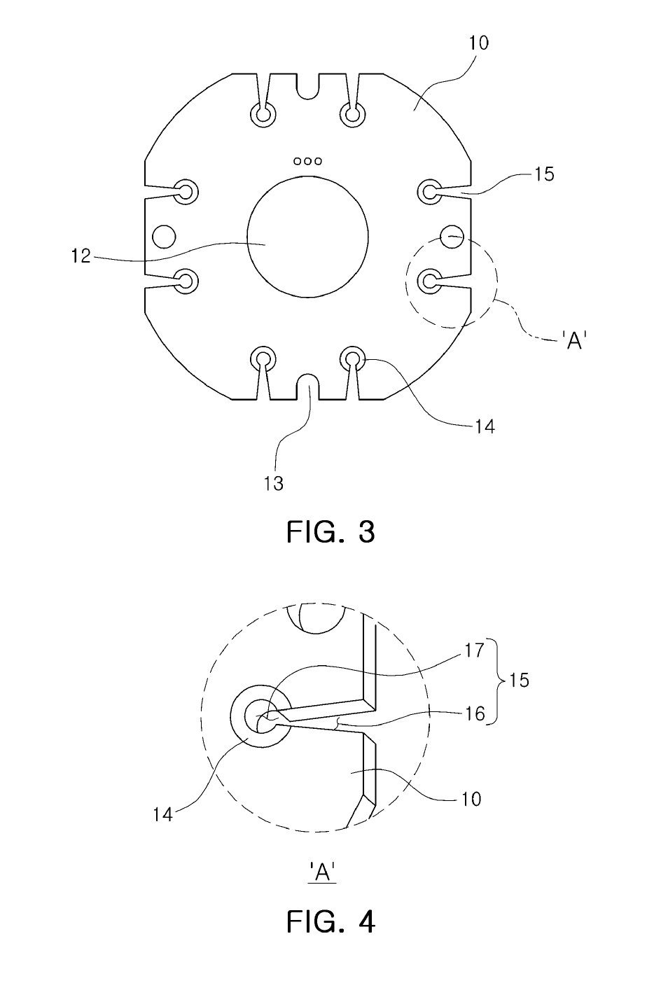

FIG. 1 is a perspective view schematically illustrating a motor according to an embodiment of the present invention. FIG. 2 is an exploded perspective view schematically illustrating the motor of FIG. 1. FIG. 3 is a plan view schematically illustrating a control board of FIG. 1. FIG. 4 is an enlarged view of portion ‘A’ in FIG. 3.

Referring to FIGS. 1 through 4, a motor 100 according to the present embodiment may include a stator 1 and a control board 10.

The stator 1 may have a tubular shape, and a coil 5 may be wound around a protrusion 2 formed within the stator 1. In this case, the coil 5 may be wound around a plurality of protrusions 2, respectively, and may be electrically connected to the control board 10 as described hereinafter.

Meanwhile, a rotor (not shown) may be inserted into an inner space of the stator 1. The rotor may include a permanent magnet 1 and a shaft 20. The permanent magnet is electromagnetically coupled to the coil 5 wound around the stator 1 to rotate the rotor.

The shaft 20 may be coupled to the permanent magnet to form a rotational shaft of the rotor. Also the shaft 20 transmits rotatory power to a component fastened to one end thereof.

The control board 10 may be a circuit board with a wiring pattern (not shown) formed thereon, and various electromagnetic elements may be mounted on at least one surface thereof.

A through hole 12 may be formed in the center of the control board 10 to allowing the shaft 20 to pass there through.

Also, the control board 10 may include at least one coil insertion recess 15 and a bonding pad 14.

As illustrated in FIG. 4, the coil insertion recess 15 is a recess formed from an outer edge of the control board 10 toward the interior of the control board 10. The coil insertion recess 15 may include a guide recess 16 and a coupling recess 17.

The guide recess 16 guides the coil 5 to the coupling recess 17. Thus, the guide recess 16 may be formed on an outer edge of the control board 10 and may have a shape in which a width thereof is reduced toward the interior of the control board 10.

Namely, the guide recess 16 may have a width greater than a diameter of the coil 5 at an outer edge of the control board 10 and may have a width similar to or smaller than the diameter of the coil 5 in a direction towards the coupling recess 17.

The coupling recess 17 may have a shape extending the guide recess 16 from an end of the guide recess 16. The coupling recess 17 is a portion allowing the coil 5 to be fixed therein, and a lead-out wire 6 of the coil 5 may be fixedly inserted into the coupling recess 17 according to an embodiment of the present invention. To this end, the coupling recess 17 may be formed as a circular hole having a diameter slightly smaller than a diameter of the lead-out wire 6.

Meanwhile, the configuration of the present invention is not limited thereto and the coupling recess 17 may have a diameter equal to that of the lead-out wire 6 of the coil 5 or a diameter greater than that of the coil 5.

Also, in the present embodiment, the diameter of the lead-out wire 6 may refer to a diameter of the coil 5 in an unclad state, i.e., a diameter of only a metal wire of the coil 5. However, the present invention is not limited thereto and the diameter of the lead-out wire 6 may be a diameter of the coil 5 in a clad state.

The bonding pad 14 may be formed around the coupling recess 17. The bonding pad is provided to allow the coil 5 to be electrically, physically connected to the control board 10. Thus, the bonding pad 14 may be electrically connected to wiring patterns formed on the control board 10, and may be formed as part of the wiring patterns.

The bonding pad 14 may be formed on one surface of the control board 10 according to a shape of the coupling recess 17. Namely, the bonding pad 14 may have an annular shape according to the shape of the coupling recess 17 formed to correspond to the diameter of the coil 5.

The coil 5 may be bonded to the bonding pad 14 by a conductive solder, or the like. Namely, the coil 5 may be connected to the control board 10 through a method such as soldering, or the like.

The control board 10 may be coupled to one side of the stator 1. Here, the control board 10 may be coupled to the stator 1 through a fixing screw, or the like, but the present invention is not limited thereto. Namely, a plurality of protrusions may be formed on the stator 1, and when the stator 1 and the control board 10 are coupled, the protrusion may be soften-melted into a fixing recess 13 to fixedly couple the control board 10 to the stator 1, or the control board 10 may be attached to the stator 1 with an adhesive, or the like. Namely, various applications may be implemented as necessary.

A method for manufacturing a motor according to the present embodiment will be described.

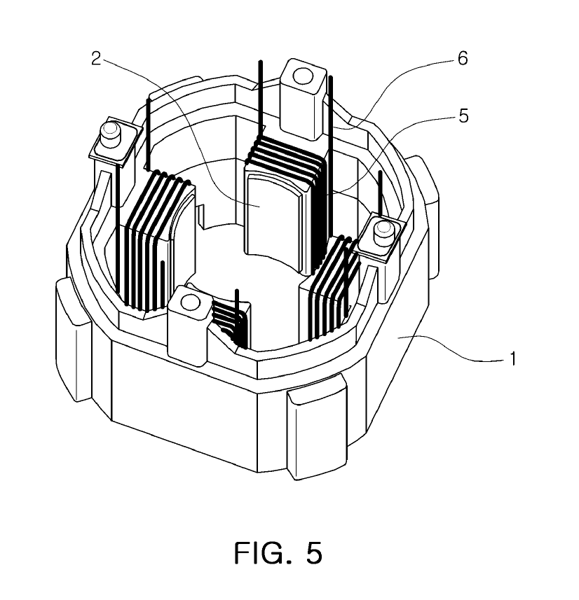

FIGS. 5 through 8 are views illustrating a method for manufacturing a motor according to an embodiment of the present invention.

Referring to FIG. 5, in a method for manufacturing a motor according to the present embodiment, first, the stator 1 with the coil 5 wound therearound is prepared. In the present embodiment, a case in which coils 5 are wound around four protrusions 2 is taken as an example, but the present invention is not limited thereto.

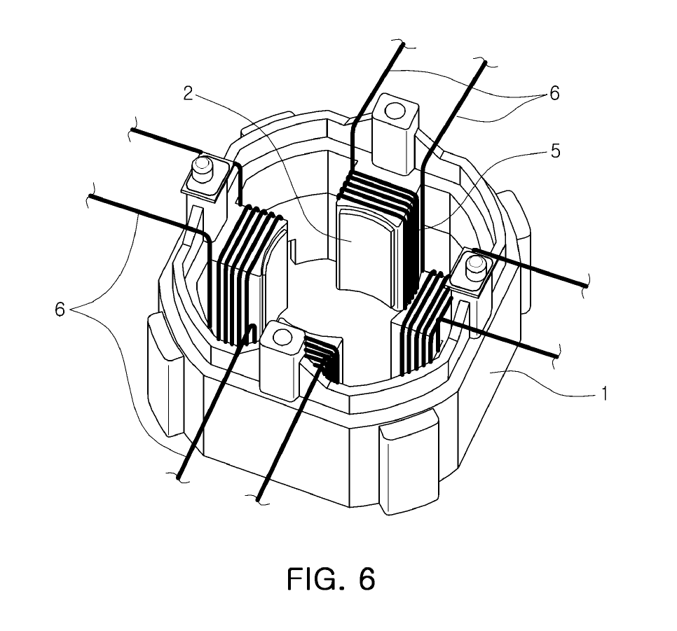

Subsequently, as illustrated in FIG. 6, lead-out wires 6 led out to the outside, of the coils 5 of the stator 1 are disposed on an outer side of the stator 1. Here, the lead-out wires 6 may be bent in an outer diameter direction from the stator 1, i.e., radially, so as to be disposed.

Also, the lead-out wires 6 may be disposed in positions corresponding to the positions of the guide recesses 16 formed in the control board 10.

Meanwhile, before or after the lead-out wires 6 are disposed at an outer side of the stator 1, the rotor may be insertedly disposed within the stator 1. Here, the technique of disposing the rotor within the stator is known, so a detailed description thereof will be omitted.

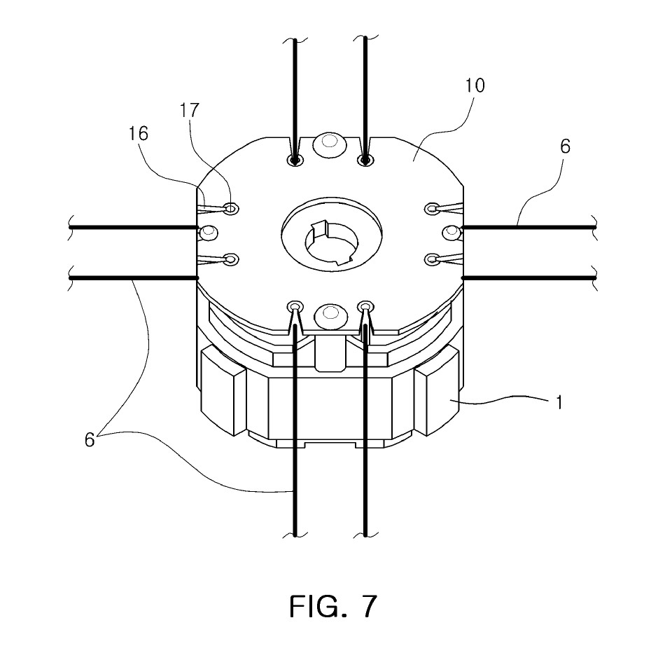

Subsequently, the control board 10 is coupled to the stator 1. Here, as illustrated in FIG. 7, the lead-out wires 6 may be disposed in positions corresponding to the guide recess 16 formed in the control board 10 or may be disposed within the guide recess 16.

Meanwhile, although not shown, in order to dispose the lead-out wires 6, fixing recesses (not shown) may be formed on the stator 1. The fixing recesses may be formed in positions corresponding to the guide recess 16, i.e., at lower portions of the guide recess 16 vertically. In the presence of the fixing recesses, after the lead-out wires 6 are led out to the outside of the stator 1, the lead-out wires 6 may be temporarily disposed in the fixing recesses, and thus, the lead-out wires 6 may be easily disposed in the positions corresponding to the guide recesses.

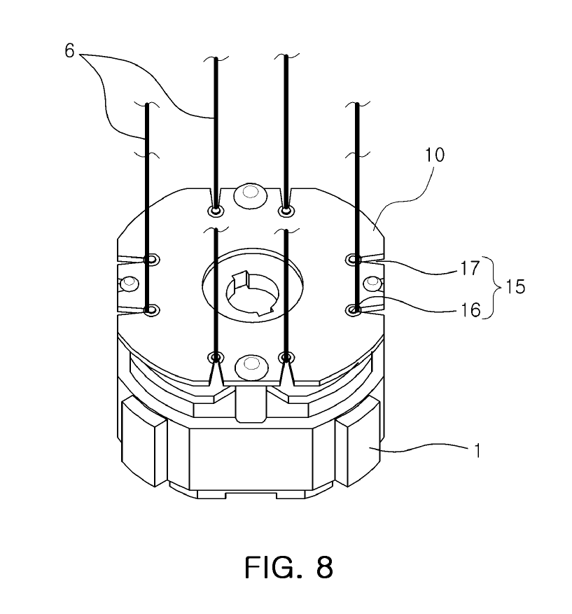

Subsequently, the lead-out wires 6 are inserted into the coupling recesses 17. Namely, as illustrated in FIG. 8, the respective lead-out wires 6 may be moved in the inward direction of the control board 10 along the guide recesses 16 so as to be inserted into the coupling recesses 17.

As described above, when the diameter of the coupling recess 17 of the control substrate 10 is equal to or slightly smaller than the diameter of the lead-out wire 6 of the coil 5, the lead-out wires 6 inserted into the control board 10 may be insertedly fixed to the coupling recesses 17.

Also, when the diameter of the coupling recess 17 is greater than the diameter of the lead-out wire 6, the lead-out wire 6 may be inserted into the coupling recess 17 and subsequently bent so as to be fixed in the coupling recess 17.

In this manner, when the lead-out wires 6 are fixed to the coupling recesses 17, the lead-out wires 6 and the control board 10 are electrically and physically connected. This process may be performed by bonding (i.e., soldering) the lead-out wires 6 and the bonding pad 14 of the control board 10 with a conductive solder.

Thereafter, unnecessary portions of the lead-out wires 6 are removed to complete the motor 100 according to the present embodiment illustrated in FIG. 1. Here, the shaft 20 may be coupled when the rotor is coupled to the stator 1, and after the coupling of the control board 10 is completed, the shaft 20 may be coupled to the rotor through the through hole (12 in FIG. 3) of the control board so as to be integrally formed therewith.

Meanwhile, in order to facilitate bonding, portions of the lead-out wires 6 exposed to the outside of the control board 10, namely, portions bonded to the bonding pad 14 by a conductive solder, may be stripped in advance.

In this case, the exposed portions of the lead-out wires 6 may be stripped immediately after the coil 5 is wound around the stator 1 or may be stripped after the lead-out wires 6 of the coil 5 are bent in the outer diameter direction from the stator 1. Also, the exposed portions of the lead-out wires 6 may be stripped after the control board 10 is coupled.

Also, in the case of using a conductive solder at a high temperature during the process of bonding the lead-out wires 6 and the control board 10, the covering (insulation layer) of the exposed portions of the lead-out wires 6 may be melt so as to be removed due to the high temperature of the conductive solder, without separately performing stripping, so, in this case, the process of performing stripping may be omitted.

Through this process, the motor according to an embodiment of the present invention may be manufactured.

In the case of the motor and the manufacturing method thereof as described above, the elaborate operation of inserting the lead-out wires of the coil into a through hole of the control board is omitted, facilitating manufacturing of the motor and shortening a manufacturing time.

Also, without the necessity of stripping the coil in advance, after the coil is inserted into the coupling recess, the coil may be stripped, so such a process of measuring a stripping length according to the stripping the coil, or the like, in advance, as in the related art, can be omitted.

In addition, since the lead-out wires of the coil can be fixedly coupled to the control board only according to a movement of the coil, the manufacturing of the motor may be automated.

The motor and the manufacturing method thereof according to an embodiment of the present invention are not limited to the foregoing embodiment and may be variously modified by a person skilled in the art within the scope of the technical concept of the present invention.

For example, in the foregoing embodiment, the coil insertion recess is formed on an outer edge of the control board in a direction perpendicular thereto, but the present invention is not limited thereto.

Namely, the coil insertion recess may be formed as a recess having a bent portion having a shape such as ‘ [symbol] ’ or ‘ [symbol] ’.

Also, in the foregoing embodiment, the coupling recess and the guide recess are clearly separated from one another, but the coupling recess and the guide recess may be formed as a single continuous recess, and in this manner, various applications may be possible.

Also, in the foregoing embodiment, the stator has a tubular shape and the rotor is disposed within the stator, but the present invention is not limited thereto. Namely, the rotor may be disposed to have a tubular shape and the stator may be disposed within the rotor.

Also, in the foregoing embodiment, the bonding pad is only formed around the coupling recess of one surface of the control board, but the present invention is not limited thereto. For example, the bonding pad may also be formed on an inner circumferential surface of the hole formed by the coupling recess, and may also be formed at a position spaced apart from the coupling recess, rather than in the vicinity of the coupling recess.

Also, the bonding pad may be formed on the inner circumferential surface of the coupling recess and the lead-out wires of the coil may be very firmly inserted into the coupling recess, so as to be electrically and physically connected without soldering.

In addition, in the present embodiment, the case of employing the switched reluctance motor has been described, but the present invention is not limited thereto and may be variously applied to any electronic device as long as it has a coil and a control board connected thereto.

As set forth above, according to embodiments of the invention, a lead-out wire of a coil is inserted into the control board through a guide recess formed in the control board. Thus, such an elaborate operation of inserting a lead-out wire of a coil into a through hole of a control board as in the related art may be omitted, and thus, the motor can be easily manufactured and manufacturing time can be shortened.

In addition, since the coil may be stripped after being inserted into the coupling recess, without the necessity of being stripped in advance, such a process of measuring a stripping length of the coil according to stripping of the coil, or the like, as in the related art may be omitted.

In addition, since the lead-out wire of the coil is fixedly coupled to the control board only through a movement of the coil, the manufacturing may be automated.

While the present invention has been shown and described in connection with the embodiments, it will be apparent to those skilled in the art that modifications and variations can be made without departing from the spirit and scope of the invention as defined by the appended claims.

What is claimed is:

1. A motor comprising:
a stator with a coil wound therearound; and
a control board coupled to one side of the stator, the coil being electrically connected to the control board,
wherein the control board includes a coupling recess in which the coil is fixedly bonded and a guide recess allowing the coil to be moved into the coupling recess from the outside of the control board.

2. The motor of claim 1, wherein the guide recess is configured as a path connecting an outer side of the control board and the coupling recess.

3. The motor of claim 2, wherein the coupling recess extends from the guide recess.

4. The motor of claim 2, wherein the guide recess has a width reduced in a direction toward the coupling recess.

5. The motor of claim 2, wherein the guide recess has a width corresponding to a diameter of the coil in a direction toward the coupling recess.

6. The motor of claim 1, wherein the control board has a bonding pad bonded to the coil in the vicinity of the coupling recess.

7. A method for manufacturing a motor, the method comprising:
preparing a stator with a coil wound therearound;
disposing a lead-out wire of the coil such that it is bent in an outer diameter direction from the stator; coupling the control board to one side of the stator; and
inserting the lead-out wire into a coupling recess of the control board.

8. The method of claim 7, wherein in the inserting of the lead-out wire, the lead-out wire is moved through a guide recess formed near the coupling recess from an outer side of the control board.

9. The motor of claim 8, wherein in the disposing of the lead-out wire of the coil by bending, the lead-out wire is disposed in a position corresponding to the guide recess of the control board.

10. The motor of claim 8, further comprising: bonding the lead-out wire to the bonding pad formed in the vicinity of the coupling recess.
